(19) United States
(12) Patent Application Publication
(10) Pub. No.: US 2017/0237507 A1
(43) Pub. Date: Aug. 17, 2017

(54) COHERENT CHANNEL MIXING FOR OBFUSCATED OPTICAL COMMUNICATIONS

(71) Applicants: PATRICK DUMAIS, OTTAWA (CA); MOHAMMAD MEHDI MANSOURI RAD, KANATA (CA)

(72) Inventors: PATRICK DUMAIS, OTTAWA (CA); MOHAMMAD MEHDI MANSOURI RAD, KANATA (CA)

(73) Assignee: HUAWEI TECHNOLOGIES CO., LTD., Shenzhen (CN)

(21) Appl. No.: 15/041,693

(22) Filed: Feb. 11, 2016

(51) Int. Cl. H04B 10/85; H04Q 11/00

(52) U.S. Cl. CPC H04B 10/85; H04Q 11/0066; H04Q 2011/0073

(57) ABSTRACT

Aspects of the present disclosure involve coherently mixing information in a first optical signal with information from one or more other optical signals, the optical signals being synchronous, to generate a mixed optical signal that obfuscates the information of the first optical signal. Each of the other optical signals is likewise mixed with a combination of the first and/or other optical signals resulting in a collection of mixed optical signals, none of which resemble the original first and other optical signals. When each of the mixed optical signals is transmitted in a separate optical fiber, then eavesdropping on only a single fiber cannot yield an unambiguous recovery of any one of the original optical signals.

### FIELD OF THE DISCLOSURE

This application relates to optical communication systems, in particular obfuscation of transmitted optical signals to aid in security of signal transmission.

### BACKGROUND

Optical transmission over a network can be subject to eavesdropping. It is possible to tap into an optical fiber and recover what is being transmitted on the fiber without the sender or receiver knowing that the fiber has been tapped.

The most common solution to address such eavesdropping is to employ the use of numerical encryption of data being sent over the network. Such encryption is generally performed in the digital domain before transmission. However, numerical encryption requires additional costs in processing power and overhead in establishing numerical encryption keys, as well as additional equipment and energy. Encryption can also be nullified, if the encryption keys used to encrypt the data are discovered.

An alternative to encrypting the data in the digital domain with an encryption algorithm or encryption key would be beneficial.

### SUMMARY OF THE DISCLOSURE

According to an embodiment of the disclosure there is provided a device including an optical mixer. The optical mixing device is configured to: receive N modulated synchronous optical signals, N≧2, having a same carrier wavelength; coherently mix the modulated synchronous optical signals and generate N mixed optical signals, each mixed optical signal including a respective component of at least two of the N modulated synchronous optical signals; and output each mixed optical signal on a respective physical channel.

According to another embodiment of the disclosure there is provided a method including a step of coherently mixing N modulated synchronous optical signals, N≧2, having a same carrier wavelength, to generate an equivalent number of mixed optical signals, each mixed optical signal including a respective component of at least two of the N modulated synchronous optical signals. A further step involves transmitting each mixed optical signal on a respective physical channel.

According to yet another embodiment of the disclosure there is provided a device including an optical mixer. The optical mixer is configured to receive N optical signals, N≧2, each on a respective physical channel, each optical signal including a respective component of each of at least two of N modulated synchronous optical signals from an originating transmission source; and coherently mix the received optical signals to recover the N modulated synchronous optical signals.

According to a further embodiment of the disclosure there is provided a method including a step of receiving N optical signals, N≧2, from N respective physical channels, each received optical signal including a respective component of each of at least two of N modulated synchronous optical signals from an originating transmission source. A further step involves recovering the N modulated synchronous optical signals by coherently mixing the N received optical signals.

According to still another embodiment of the disclosure there is provided a system including a transmitter, a receiver and at least two physical channels connecting the transmitter and receiver. The transmitter includes: a first optical mixer configured to: receive N modulated synchronous optical signals, N≧2, having a same carrier wavelength; coherently mix the modulated synchronous optical signals and generate N mixed optical signals, each mixed optical signal including a respective component of at least two of the modulated synchronous optical signals; and output each mixed optical signal on the at least two respective physical channels. The receiver includes a second optical mixer configured to: receive N mixed optical signals from the at least two physical channels; and coherently mix the received mixed optical signals to recover the N modulated synchronous optical signals.

Other aspects and features of the present disclosure will become apparent, to those ordinarily skilled in the art, upon review of the following description of the various embodiments of the disclosure.

### BRIEF DESCRIPTION OF THE DRAWINGS

Embodiments will now be described with reference to the attached drawings in which:

FIG. 1 is a block diagram of an optical network configured to perform coherent channel mixing according to an embodiment of the disclosure;

FIG. 2A is a block diagram of a 3 dB coupler that may be used for optical mixing according to embodiments of the disclosure;

FIG. 2B is a block diagram of 180-degree hybrid coupler that may be used for optical mixing according to embodiments of the disclosure;

FIG. 20 is a block diagram of four 3 dB couplers arranged in a manner that may be used for optical mixing according to embodiments of the disclosure;

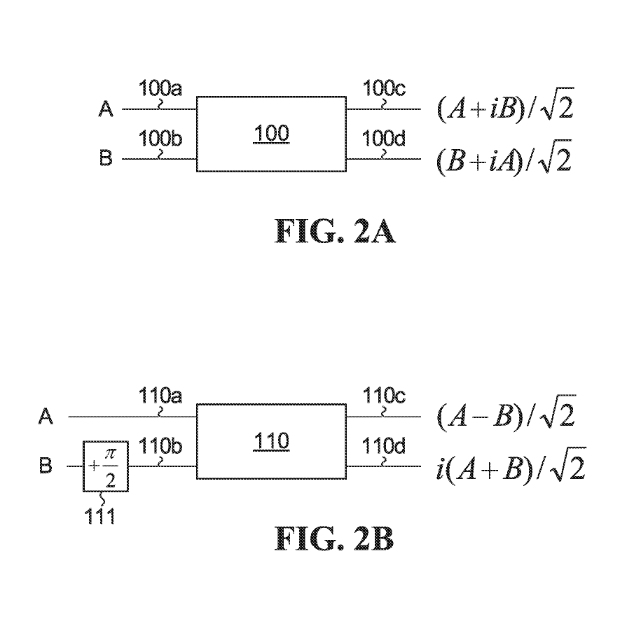

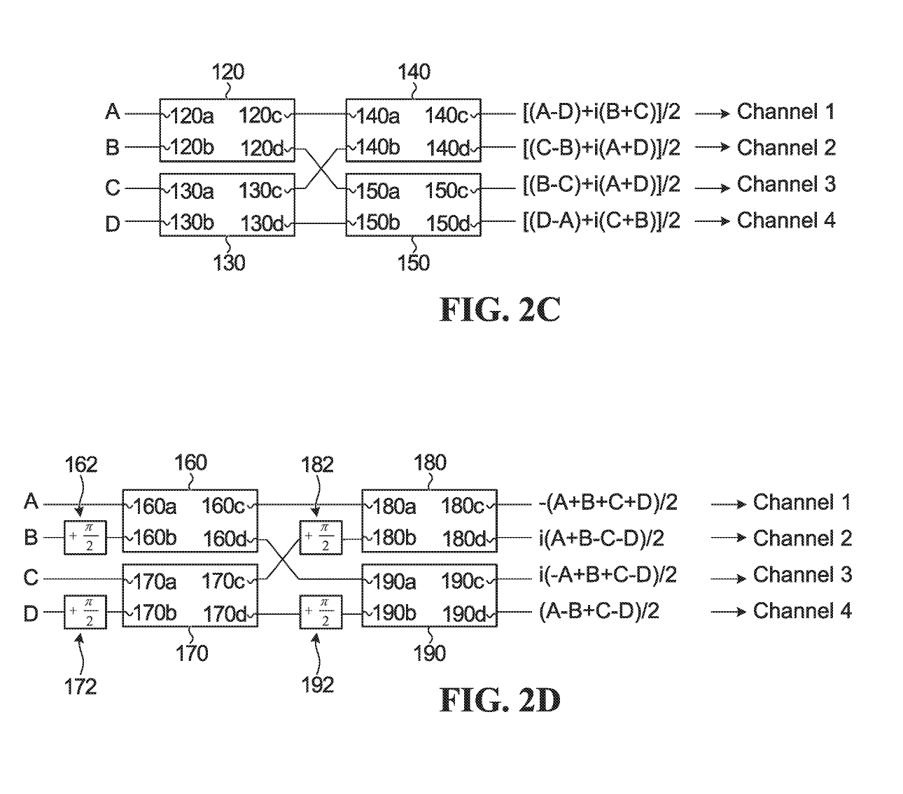

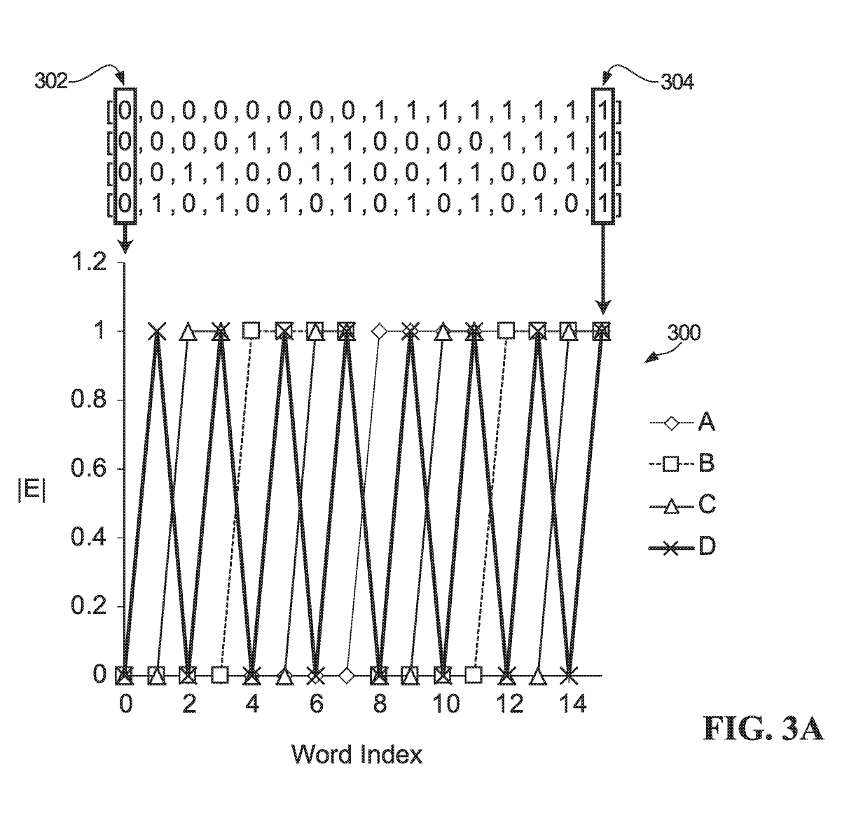

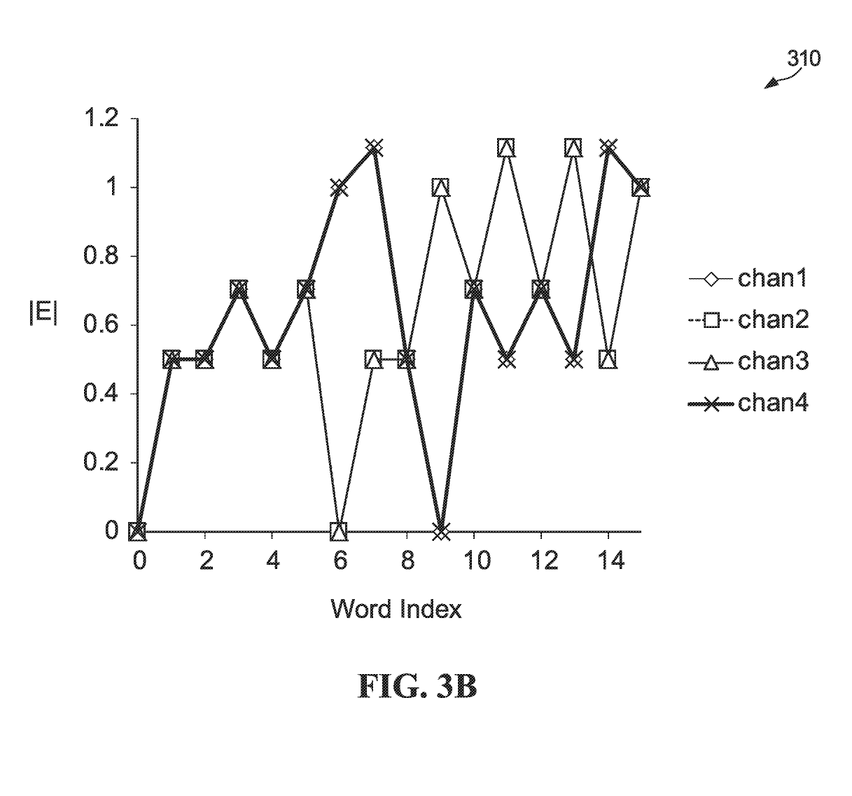

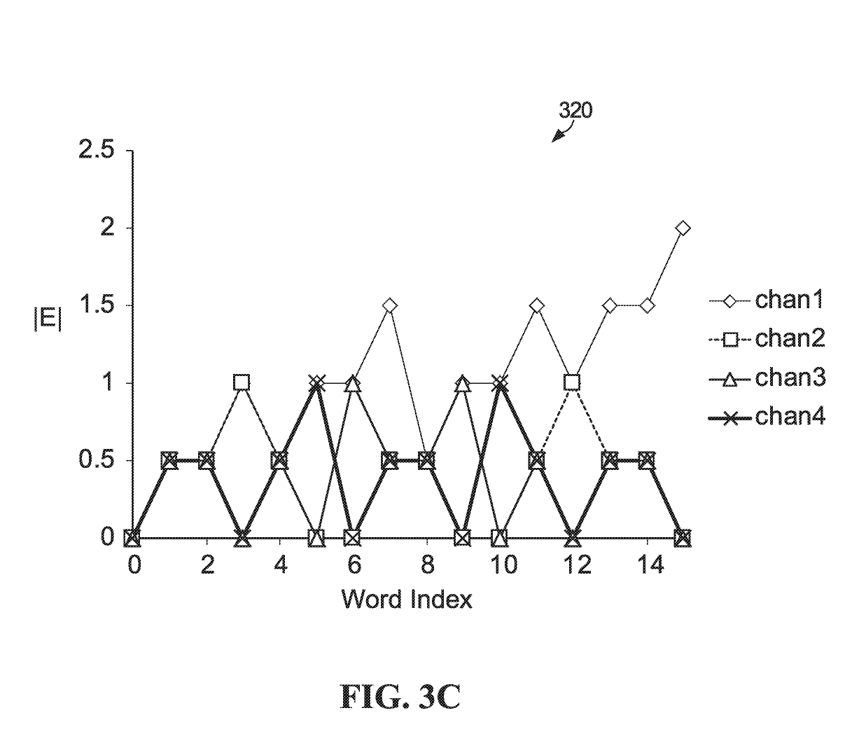

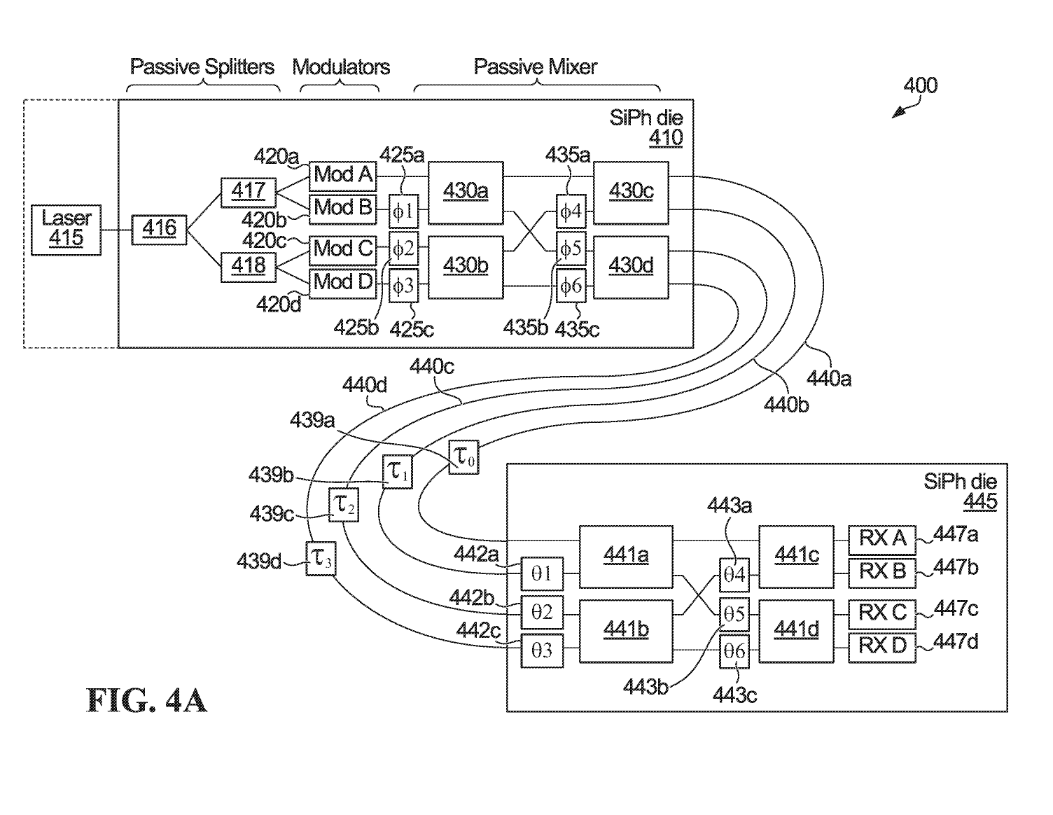

FIG. 2D is a block diagram of a four 180-degree hybrid couplers arranged in a manner that may be used for optical mixing according to embodiments of the disclosure:

FIG. 3A is a plot of four example input signals that could be applied to the arrangement of couplers in either FIG. 2C or 2D;

FIG. 3B is a plot of four example output signals that are generated based on the arrangement of couplers in FIG. 2C;

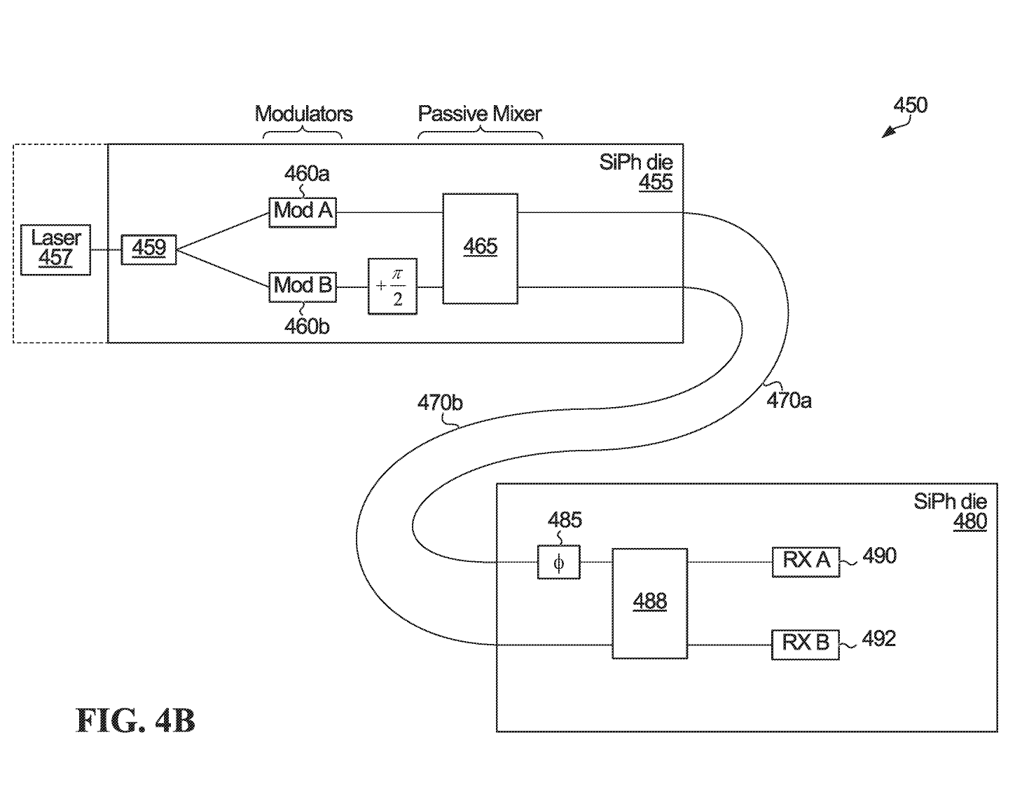

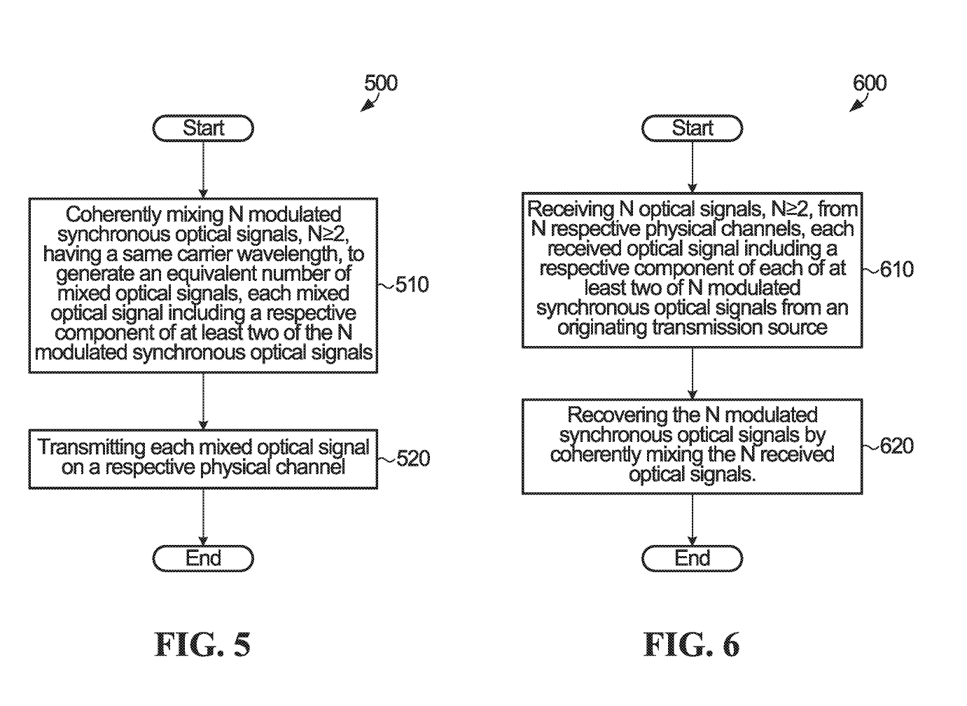

FIG. 3C is a plot of four example output signals that are generated based on the arrangement of couplers in FIG. 20;

FIG. 4A is a block diagram of an example implementation of a system, including transmitter and receiver, configured to perform coherent channel mixing according to an embodiment of the disclosure;

FIG. 4B is a block diagram of another example implementation of a system, including transmitter and receiver, configured to perform coherent channel mixing according to an embodiment of the disclosure;

FIG. 5 is a flow chart illustrating an example of a method occurring in a transmitter according to an embodiment of the disclosure; and

FIG. 6 is a flow chart illustrating an example of a method occurring in a receiver according to an embodiment of the disclosure.

### DETAILED DESCRIPTION OF EMBODIMENTS

It should be understood at the outset that although illustrative implementations of one or more embodiments of the present disclosure are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

Aspects of the present disclosure involve coherently mixing information in a first optical signal with information from one or more other optical signals, the optical signals being synchronous, to generate a mixed optical signal that obfuscates the information of the first optical signal. Each of the other optical signals is likewise mixed with a combination of the first and/or other optical signals resulting in a collection of mixed optical signals, none of which resemble the original first and other optical signals. When each of the mixed optical signals is transmitted in a separate optical fiber, then eavesdropping on only a single fiber cannot yield an unambiguous recovery of any one of the original optical signals. Furthermore, if one or more fibers carrying a mixed optical signal are to be routed separately from the routing of other fibers carrying mixed signals, the possibility of eavesdropping at a single point along the transmission pathway and being able to recover any of the original optical signals is further reduced.

The expression “coherently mixing” is intended to mean that the optical signals that are being mixed are signals of a same carrier wavelength.

The expression “optical signals being synchronous” is intended to mean that the optical signals are aligned in time and the alignment needs to be maintained for recovery of the original signals at the receiver. As each mixed optical signal includes components of one or more other signals, the mixed optical signals must maintain a reasonable alignment in time in order that the components of each original signal from the mixed signals properly align when the mixed signals are mixed again at the receiver. As long as channels connecting respective outputs of the transmitter with respective inputs of the receiver are substantially the same length, or if the channels are routed differently, routes with a shorter path length are provided with an appropriate delay so that all paths from the transmitter to receiver are the same effective length for each channel, the original signals can be recovered at the receiver, with substantially the same relative alignment as when they were mixed at the transmitter. Otherwise, if the mixed signals do not arrive at the same time, then when the mixed signals are mixed together the original signals may not be recovered. In this particular definition it is not intended that the signals be specifically aligned with one another at a given reference point in time of the respective optical signals, such as at a packet boundary for instance, merely that the optical signals are being mixed in such a way that once the input optical signals are mixed together to create the mixed optical signals, discrete points in the mixed optical signals that were aligned in a time upon being mixed, should be mixed together again at the receiver when they are likewise temporally aligned. However, in some embodiments, two or more signals may be aligned with regard to a particular reference point within one of the optical signals.

Mixing information from different optical signals can be performed optically at the transmitter level and results in the total information of a given optical signal being divided into separate physical channels. This may include the optical signal being divided over at least two channels of the total number of channels up to all of the channels. The total information can be recovered for each optical signal by performing a mixing process that is the inverse to the mixing process that generated the mixed signals at the transmitter.

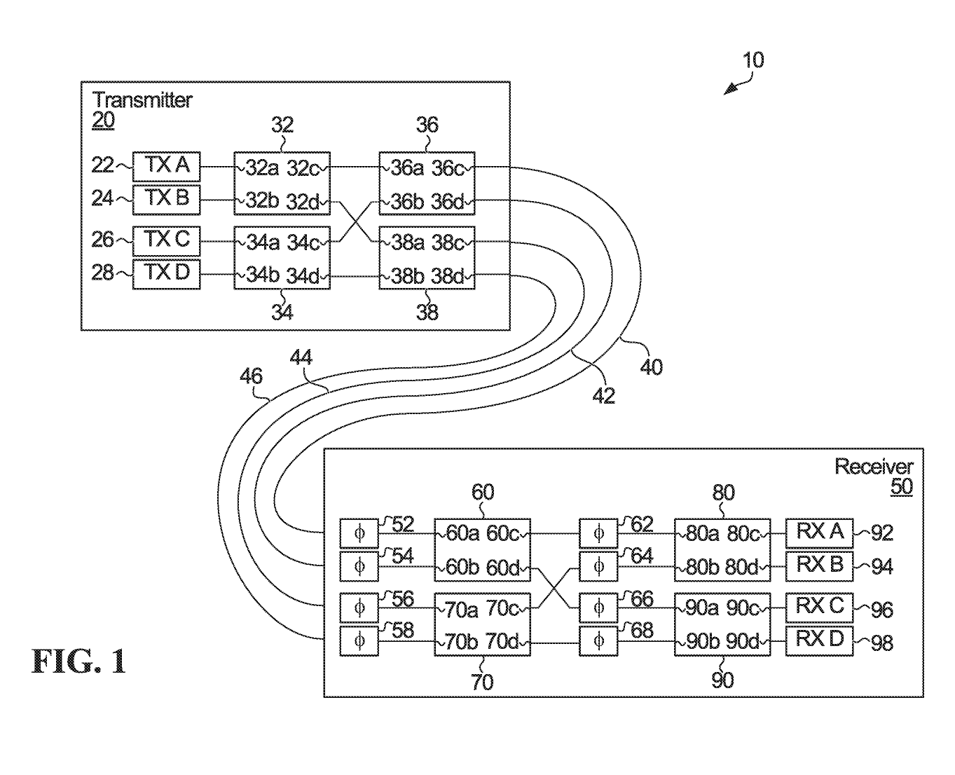

Referring to FIG. 1, an example of an embodiment of the disclosure will now be described for a system 10 including both a transmitter 20 and receiver 50. In the particular example of FIG. 1, the transmitter 20 includes four transmitter elements 22,24,26,28. Each transmitter element is coupled to an input port of a 4 port coupler. The first transmitter element 22 is coupled to a first input port 32a of a first coupler 32. The second transmitter element 24 is coupled to a second input port 32b of the first coupler 32. The third transmitter element 26 is coupled to a first input port 34a of a second coupler 34. The fourth transmitter element 28 is coupled to a second input port 34b of the second coupler 34. A first output port 32c of the first coupler 32 is coupled to a first input port 36a of a third coupler 36. A second output port 32d of the first coupler 32 is coupled to a first input port 38a of a fourth coupler 38. A first output port 34c of the second coupler 34 is coupled to a second input port 36b of the third coupler 36. A second output port 34d of the second coupler 34 is coupled to a second input port 38b of a fourth coupler 38. Output ports 36c,36d,38c,38d of the third and fourth couplers 36,38 are each coupled into separate respective fibers 40,42,44,46. In the particular example of FIG. 1, these four fibers 40,42,44,46 each carry a mixed optical signal having components of all four original outputs from the first to fourth transmitter elements 22,24,26,28.

In some embodiments, the transmitter elements 22,24,26,28 in FIG. 1 may each include a laser source and a modulator for generating a modulated signal. In other embodiments the transmitter elements may collectively include a single laser source, splitters to divide the radiation emitted by the laser and a respective modulator for each input to the first and second couplers. More generally, the transmitter elements are considered a combination of optical components, discrete or fabricated together, or some combination of discrete and fabricated elements, that provides an optical signal to an optical mixing device.

In the particular example of FIG. 1 the four 4 port couplers 32, 34, 36, 38 together form a mixer that mixes the signals provided to four inputs ports 32a, 32b, 34a, 34b of the first 32 and second 34 couplers together in such a manner that the mixed optical signals output from the third 36 and fourth 38 couplers each include a component of all four input optical signals. In alternative embodiments, instead of the couplers as shown in FIG. 1, the mixing may be performed by an analog optical switch, for example a collection of tunable couplers. Therefore, in place of four optical couplers, a single mixing element might be a collection of tunable couplers with N inputs and N outputs. The collection of tunable couplers is configured to mix the N inputs in such a manner that each of the outputs includes components of at least two signals input to the collection of tunable couplers. The more optical signals that are mixed together and components thereof that appear on each output signal, the more difficult an original modulated signal may be to recover when the mixed signals are mixed together in a complementary way to recover the original signals.

Furthermore, the mixing may be performed such that each mixed signal does not include components of all of the input optical signals. For example, in a different implementation with six inputs to a collection of six couplers, six input optical signals are input to the inputs of three 4 port couplers in much the same manner as described above with regard to the four inputs applied to two 4 port couplers shown in FIG. 1. The outputs of those three 4 port couplers could be provided to the inputs of a second group of three 4 port couplers such that a first output of the first coupler and a first output of a second coupler are mixed by a fourth coupler, a second output of the first coupler and a first output of a third coupler are mixed by a fifth coupler and a second output of the second coupler and a second output of the third coupler are mixed by a sixth coupler. In such a scenario the fourth coupler would output two mixed signals that have components of the first, second, third and fourth inputs, the fifth coupler would output two mixed signals that have components of the first, second, fifth and sixth inputs and the sixth coupler would output two mixed signals that have components of the third, fourth, fifth and sixth inputs.

More generally, the number of inputs and the number of mixing devices may be limited by the number of inputs that are substantially equal in power that can be applied to a single mixing device and that provides a similar number of outputs that are mixed together such that each input is mixed with one or more other inputs. The expression of “substantially equal in power” is intended to mean that the inputs are close to the same power within an acceptable margin. This may be within 10 percent of each other in some embodiments or as much as 50 percent of each other in some other embodiments.

FIG. 2A is a schematic of a 4 port 3 dB coupler 100. An input to a first input port 100a is represented by “A” and an input to a second input port 100b is represented by “B”. The mixing process of the 3 dB coupler results in an output of (A+iB)/√2 at a first output port 100c and an output of (B+iA)√2 at a second output port 100d of the 3 dB coupler 100.

In addition to 4 port 3 dB couplers that have 2 inputs, 2 outputs and mix the inputs substantially equally if the input powers are substantially equal, there also exist 3×3 couplers that can mix three inputs of substantially equal power such that each output has a component of each of the three inputs in substantially equal portion. Such a 3×3 coupler and other N×N coupler variations could be utilized as mixing devices in embodiments of the present disclosure.

FIG. 2B is a schematic of a 4 port 180-degree hybrid coupler 110. The 4 port 180-degree hybrid coupler 110 is similar to the 4 port 3 dB coupler shown in FIG. 2A, except that one of the inputs includes a phase shifter 111 introducing a passive π/2 phase shift. An input to a first input port 110a is represented by “A” and an input to a second input port 110b is represented by “B”. The mixing processing of the 180-degree hybrid coupler results in an output of (A−B)/√2 at a first output port 110c and an output of i(A+B)/√2 at a second output port 110d.

FIG. 2C is a schematic of an arrangement of four 4 port 3 dB couplers 120,130,140,150 in a similar arrangement to that shown in each of the transmitter and receiver of FIG. 1, where inputs A, B, C and D are optically coupled to input ports 120a,120b,130a,130b, respectively, of the first two couplers 120,130. A first output port 120c of coupler 120 is optically coupled to a first input port 140a of coupler 140. A second output port 120d of coupler 120 is optically coupled to a first input port 150a of coupler 150. A first output port 130c of coupler 130 is optically coupled to a second input port 140b of coupler 140. A second output port 130d of coupler 130 is optically coupled to a second input port 150b of coupler 150. An output on Channel 1 from output port 140c, after mixing, is [(A−D)+i(B+C)]/2. Likewise, the output on Channel 2 from output port 140d is [(C−B)+i(A+D)]/2, the output from output port 150c on Channel 3 is [(B−C)+i(A+D)]/2, and the output from output port 150d on Channel 4 is [(D−A)+i(C+B)]/2. As can be seen from these results, a component of each of the signals A,B,C,D from the first to fourth inputs appears in each of the resultant mixed signals. Thus, when such an arrangement of couplers is used at the transmitter, the manner to best recover the original signals with the least amount of error is to use a similar arrangement of couplers to mix the four mixed signals together in a complementary manner as was done at the transmitter. This will be described in further detail below. Without having access to one or more of the mixed signals, i.e. somewhere along the path, it is difficult to obtain any of the original signals with confidence as there will be a missing component of any of the original signals that are included in the mixed signal that is not accessible, even if the signals that are accessible are mixed together in an otherwise correct manner.

FIG. 2D is a schematic of an arrangement of four 4 port 180-degree hybrid couplers 160,170,180,190 in a similar arrangement to that shown in each of the transmitter and receiver of FIG. 1, where inputs A and C are optically coupled to input ports 160a and 170a of the first two couplers 160,170, respectively. Inputs B and C are optically coupled to phase shifters 162 and 172, respectively, and outputs from the phase shifters 162,172 are optically coupled to the input ports 160b and 170b of the first two couplers 160,170, respectively. A first output port 160c of coupler 160 is optically coupled to a first input port 180a of coupler 180. A second output port 160d of coupler 160 is optically coupled to a first input port 190a of coupler 190. A first output port 170c of coupler 170 is optically coupled to phase shifter 182 and phase shifter 182 is optically coupled to a second input port 180b of coupler 180. A second output port 170d of coupler 170 is optically coupled to phase shifter 192 and phase shifter 192 is optically coupled to a second input port 190b of coupler 190. An output on Channel 1 from output port 180c, after the mixing, is −(A±B+C+D)/2. Likewise, the output from output port 180d on Channel 2 is i(A+B−C−D)/2, the output from output port 190c on Channel 3 is i(−A+B+C−D)/2, and the output from output port 190d on Channel 4 is (A−B+C−D)/2. Once again, a component of each of the signals A,B,C,D from the first to fourth inputs appears in each of the resultant mixed signals.

Referring once again to FIG. 1, the optical fibers 40,42,44,46 are each optically coupled to a respective phase changing element 52,54,56,58 in the receiver 50. Each phase changing element 52,54,56,58 is coupled to an input of a respective 4 port coupler. The first phase changing element 52 is coupled to a first input port 60a of a first coupler 60. The second phase changing element 54 is coupled to a second input port 60b of the first coupler 60. The third phase changing element 56 is coupled to a first input port 70a of a second coupler 70, The fourth phase changing element 58 is coupled to a second input port 70b of the second coupler 70. A first output port 60c of the first coupler 60 is coupled to a fifth phase changing element 62 coupled to a first input port 80a of a third coupler 80. A second output port 60d of the first coupler 60 is coupled to a seventh phase changing element 66 coupled to a first input port 90a of a fourth coupler 90. A first output port 70c of the second coupler 70 is coupled to a sixth phase changing element 64 coupled to a second input port 80b of the third coupler 80. A second output port 70d of the second coupler 70 is coupled to an eighth phase changing element 68 coupled to a second input port 90b of the fourth coupler 90. Once the mixed optical signals have passed through the four 4 port couplers 60,70,80,90, which perform a complementary mixing process as at the transmitter 20, signals that are proportional to the original signals of the light emitting sources 22,24,26,28 result from the mixing process at the receiver. Outputs 80c,80d,90c,90d of the third and fourth couplers 80,90 are each coupled into separate respective receiving elements 92,94,96,98 where the recovered signals can be decoded.

In some embodiments where one or more optical fibers are routed differently from other optical fibers, and the lengths of the optical fiber are different for the different routes, there may be a time variable adjust element in the receiver 50, or collocated just prior to the receiver, in order to compensate for the difference in length and to keep the mixed signals temporally aligned with another. In some embodiments, a time variable adjust element could be located just after the transmitter or at a conveniently accessible location along the route.

While a phase changing element is shown optically coupled to each input of couplers 60,70 in FIG. 1, it is to be understood that in some embodiments, only N−1 inputs, where N is the total number of inputs, may have phase changing elements, as the N−1 phase changing elements may be used to change the phase of the N−1 inputs with respect to the input that does not have a phase changing element.

With reference to FIGS. 3A and 3B, a simple example will now be described in which “words” of four parallel binary input bits, 0 or 1, are applied to a mixer of the type shown in FIG. 2C. FIG. 3A shows 16 individual four bit words (formed in columns) in which the top row of bits represent individual A inputs, the second row of bits represent individual B inputs, the third row of bits represent individual C inputs and the fourth row of bits represent individual D inputs. Therefore, the first column 302 represents inputs of A,B,C,D [0,0,0,0] that are to be mixed together and the last column 304 represents inputs of A,B,C,D [1,1,1,1] that are to be mixed together. FIG. 3A also shows a plot 300 of the electrical field amplitude of each bit of the respective four bit word. The x-axis represents the word index of the 16 four bit words and the y-axis is the electrical field amplitude of the input bits.

FIG. 3B is a plot 310 that shows the resultant output on each channel for the mixing of the four input bits in each four bit word shown in FIG. 3A, after passing through an arrangement of four 3 dB couplers 120, 130, 140, and 150 as shown in FIG. 20. Each channel output for each four bit word has components of all four of the input bits for the respective input word. The x-axis once again represents the word index of the 16 four bit words and the y-axis is the electrical field amplitude of the mixed output on each channel.

The four mixed signals are routed through the physical channels between transmitter and receiver. When mixed by the arrangement of couplers that is the complement of the arrangement of couplers in transmitter, which in this case is the same arrangement as in the transmitter, the result is that the four original strings of bits can be recovered at the outputs of the third and fourth couplers 80,90 of the receiver.

FIG. 30 is a plot 320 that shows the resultant output on each channel for the mixing of the four input bits in each four bit word shown in FIG. 3A, after passing through an arrangement of 4 180-degree hybrid couplers 160, 170, 180, and 190 as shown in FIG. 2D. Each channel output for each four bit word has components of all four of the input bits for the respective input word. The x-axis represents the word index of the 16 four bit words and the y-axis is the electrical field amplitude of the mixed output on each channel.

As can be seen by comparing the power values in the plots of FIGS. 3A and 3B, in the case of the four 180-degree hybrid couplers, the mixing of the signals results in a greater power separation between the quantized levels of the mixed signals. This may result in an improved optical signal to noise ratios (OSNR) for the mixed signals when using the 180-degree hybrid couplers.

In some implementations, as the number of optical signals that are mixed together increases, the resulting number of levels of quantized values in the mixed signals increases as well. With more levels of quantization in a same range of minimum and maximum power levels, there is a higher possibility of error in the recovered signal due to noise. Therefore, there may be some manner of trade-off between the number of optical signals that can be mixed together and error rate for the recovered signal, which may also be dependent on the type of elements used to perform the mixing, for example 3 dB coupler versus 180-degree hybrid coupler.

More generally than the examples described above, it may be considered that a transmitting device includes an optical mixer configured to receive N modulated synchronous optical signals, N≧2. The optical mixer is configured to coherently mix the modulated synchronous optical signals and generate N mixed optical signals. Each mixed optical signal includes a respective component of at least two of the modulated synchronous optical signals and the at least one optical mixing device is configured to output each mixed optical signal on a respective physical channel.

In some embodiments each physical channel comprises a separate optical fiber.

In some embodiments where N=4 and the optical mixer includes first, second, third and fourth optical mixing devices arranged such that the first optical mixing device receives first and second modulated synchronous optical signals and the second optical mixing device receives third and fourth modulated synchronous optical signals. A first output from the first optical mixing device is optically coupled to a first input of the third optical mixing device and a first output from the second optical mixing device is optically coupled to a second input of the third optical mixing device. A second output from the first optical mixing device is optically coupled to a first input of the fourth optical mixing device and a second output from the second optical mixing device is optically coupled to a second input of the fourth optical mixing device and outputs of the third and fourth optical mixing devices include the N mixed optical signals.

In some embodiments the mixing devices can be 3 dB couplers, 180-degree hybrid couplers, a combination of both types of couplers, N×N couplers where N≧3, or a collection of tunable couplers.

In some embodiments, the transmitter device may include N modulators, each modulator optically coupled to optical inputs of the optical mixer in order to generate one of the modulated synchronous optical signals by modulating an optical signal from an optical source.

In some embodiments the optical source is a single laser optically coupled to all of the N modulators. In some embodiments the optical source is two or more lasers, locked to the same carrier wavelength, and where each laser is optically coupled to one or more of the N modulators.

More generally than the examples described above, it may be considered that a receiving device includes N optical inputs, N≧2, wherein each optical input is configured to receive an optical signal from a respective physical channel. Each optical signal includes a respective component of each of at least two of N modulated synchronous optical signals from an originating transmission source. The receiving device also includes an optical mixer. The N optical inputs are optically coupled to the optical mixer. The at least one optical mixing device is configured to coherently mix the received optical signals to recover the N modulated synchronous optical signals.

In some embodiments the receiving device includes an optical phase adjust element optically coupled to at least N−1 of the optical inputs. In some embodiments the receiving device includes a time variable adjust element optically coupled to at least N−1 of the optical inputs.

In some embodiments where N=4 optical inputs, the optical mixer may include first, second, third and fourth optical mixing devices arranged such that the first optical mixing device receives first and second received optical signals and the second optical mixing device receives third and fourth received optical signals. A first output from the first optical mixing device is optically coupled to a first input of the third optical mixing device and a first output from the second optical mixing device is optically coupled to a second input of the third optical mixing device. A second output from the first optical mixing device is optically coupled to a first input of the fourth optical mixing device and a second output from the second optical mixing device is optically coupled to a second input of the fourth optical mixing device. Outputs of the third and fourth optical mixing devices are proportional to the N modulated synchronous optical signals.

An implementation according to an embodiment of the disclosure will now be described with reference to FIG. 4A, which illustrates a system 400 including a transmitter 410 and a receiver 445. Multiple components of the transmitter 410 are implemented on a silicon phosphate (SiPh) die. A single laser 415 is part of the transmitter 410, but is not fabricated on the SiPh die itself. Three splitters 416,417,418 are fabricated on the die to divide the source radiation from the laser 415 into two paths and then each of those two paths into two paths, with a total of four paths. Each of the four paths are optically coupled to a respective modulator 420a,420b,420c,420d to modulate each of the four signals from the laser 415. Outputs from the four modulators 420a,420b,420c,420d are optically coupled to respective inputs of the collection of four 4 four port couplers 430a,430b,430c,430d in an arrangement as described in FIG. 20, with the addition of phase modulators 425a,425b,425c,435a,435b,435c coupled to at least one of the two inputs of each of the four couplers 430a,430b,430c,430d. It is understood that the optical paths linking the laser 415 to the optical couplers 430a,430b,430c,430d should be the same optical length within a tolerance that allows the signals to remain synchronous. Four fibers 440a, 440b, 440c, and 440d connect the transmitter 410 to the receiver 445. Due to likely slight differences in physical length, the four fibers 440a,440b,440c,440d may introduce distinct phase differentials τ₀, τ₁, τ₂, and τ₃ 439a,439b,439c,439d into the respective transmitted signals upon propagation in the four fibers 440a,440b,440c,440d. To compensate or lessen these phase differentials, the receiver 445 may include variable phase delay elements 442a,442b,442c coupled to three of four input ports of couplers 441a and 441b of the receiver 445. Outputs of couplers 441a and 441b are coupled to inputs of couplers 441c and 441d, either directly or via variable phase delay elements 443a,443b,443c. Four receiving elements 447a,447b,447c,447d are coupled to outputs of coupler 441c and 441d where the received signals can be decoded. The optical paths in the receiver 445 between the elements should also be the same optical path length within a tolerance that allows the signals to remain synchronous. The receiver 445 is also fabricated on a SiPh die in this example.

At the transmitter, the phase values of the phase modulators 425a,425b,425c,435a,435b,435c can vary. In a particular implementation, however, the phase values may be φ₁=π/2, φ₂=0, φ₃=π/2, φ4=π/2, φ₅=0 and φ₆=π/2. Values of the variable phase delay elements 439a,439b,439c,439d can vary dependent upon the system implementation. The phase values of the variable phase delay elements 442a,442b,442c,443a,443b,443c in the receiver may be dependent upon the phase values of the various variable phase delay elements at the transmitter. For example, in some implementations, the phase values of the variable phase delay elements of the receiver may be θ₁=π−φ₂+(τ₀−τ₁), θ₂=π−φ₂+(τ₀−τ₂), θ₃=π+φ₃−φ₁+(τ₀−τ₃), θ₄=π, θ₅=0 and θ₆=π.

In some embodiments, in addition to or instead of phase modulators 425a,425b,435a,435b shown in FIG. 4A, elements capable of adjusting time variable delays could be used in the transmitter 410. Time variable delay elements could be located anywhere between the outputs of the mixers that generated the mixed signal and the inputs of the mixers in the receiver, that is, in the transmitter 410, somewhere along the path between the transmitter 410 and the receiver 445, or in the receiver 445. In some embodiments, there may be no phase modulators or time variable adjust elements in the transmitter, as show in FIG. 1.

With reference to FIG. 4B another implementation according to an embodiment of the disclosure will now be described. FIG. 4B illustrates another system 450 including a transmitter 455 and a receiver 480. Multiple components of the transmitter 455 are implemented on a SiPh die. A single laser 457 is part of the transmitter 455, but may not be fabricated on the SiPh die itself. In this example, as only a single coupler 465 is used to mix two inputs, a single splitter 459 is fabricated on the die to divide the source radiation from the laser 457 into two paths. Each of the two paths is optically coupled to a respective modulator 460a,460b to modulate each of the two signals from the laser 457. Outputs from the two modulators 460a,460b are optically coupled to input ports of the 4 four port coupler 465 of the arrangement described in FIG. 2B. Two fibers 470a,470b connect the transmitter 455 to the receiver 480. The receiver 480 includes a single coupler 488 with a variable phase delay element 485 coupled to one of the inputs. Two receiving elements 490 and 492 are coupled to outputs of the coupler 488 where the received signals can be decoded. The receiver 480 is also fabricated on a SiPh die in this example.

While a majority of the elements shown in the transmitters 410, 455 and receivers 445, 480 in FIGS. 4A and 4B are indicated to be fabricated on a SiPh die, more generally the elements could be fabricated on substrates of other types of materials. The elements themselves could be discrete elements combined on the substrate, fabricated together on the substrate, or some combination of discrete and fabricated elements, that provide the functionality described above.

Furthermore, the examples of FIGS. 4A and 4B are not intended to be limiting in nature. These figures include a particular number and type of mixing devices in the transmitter and receiver. They also include particular number of phase adjusting and time adjusting elements in the transmitter, routing path and receiver. Numbers and implementation of such elements are system specific.

With reference to FIG. 5, a method 500 will now be described for coherent mixing from the transmitter perspective. A first step 510 of the method 500 includes coherently mixing N modulated synchronous optical signals, having a same carrier wavelength, to generate an equivalent number of mixed optical signals. Each mixed optical signal includes a respective component of two or more of the N modulated synchronous optical signals. A second step 520 includes transmitting each mixed optical signal on a respective physical channel.

In some embodiments, transmitting each mixed optical signal includes transmitting at least one of the mixed optical signals on a physical route that is distinct from a physical route, or routes, on which all other mixed optical signals are transmitted. In some other embodiments each of the mixed optical signals travels on a physical route that is distinct from physical routes of each other mixed optical signal.

In some embodiments, where N=2, only a single optical mixing device is used. In some embodiments, where N=4, two optical mixing devices are used. The optical mixing devices could be either, or both, of four port 3 dB couplers and four port 180-degree hybrid couplers. In some embodiments the at least one optical mixing device could be a collection of tunable couplers with N inputs and N outputs that mixes the N input optical signals in a way that is complementary to the transmitter mixing device or devices so as to recover the original modulated synchronous optical signals.

In some embodiments, controlling polarization of one or more of the modulated synchronous optical signals can be used to enhance a level of obfuscation of the signals. For example, one or more of the original signals may have its polarization controlled before being mixed and polarization controller optical fiber may be used between the transmitter and receiver. In other embodiments all of the signals may have their polarization controlled and each of the optical fibers may be polarization-maintaining optical fiber between the transmitter and receiver. In some embodiments, the polarization may be changed dynamically, with the transmitter and receiver being coordinated as to the changing polarization, to add a further enhancement to the obfuscation.

With reference to FIG. 6, a method 600 will now be described for coherent mixing from the receiver perspective. A first step 610 of the method 600 includes receiving N optical signals, N≧2, from N respective physical channels. Each received optical signal includes a respective component of each of at least two of N modulated synchronous optical signals from an originating transmission source. A second step 620 includes recovering the N modulated synchronous optical signals by coherently mixing the N received optical signals.

The channel mixing at the transmitter described above, which may be considered as an encoding process, is a process that can be expressed in a mathematical relation. For example, the encoding process is a linear transform that can be represented by a matrix M of dimension N×N. Input vector X includes N bits (a “word”), in which each bit represents an input for a respective channel of an optical mixer at a given time point in time. A resultant output of the mixer represented by vector Y is obtained by the operation Y=M*X.

At a receiver side, the inverse mixing is also a linear transform represented by an N×N matrix P. Thus the detected signal vector Z is expressed by the product Z=P*Y. Substituting in for Y from above, Z=P*M*X. For amplitude-modulation and detection of the signals, the information contained in the original vector X is recovered as long as the matrix product P*M results in a diagonal matrix. In other words, in the case of amplitude modulation and detection, there is no requirement for the matrix product P*M to equal to the identity matrix, for which both the amplitude and the phases of the signal vector would be recovered. The latter case may be applicable to phase-modulated signals; then the receiver matrix P should be the inverse of the transmitter matrix, P=M⁻¹. The recovery of phase information may require additional phase elements before the receivers

In some embodiments, the method may further include providing phase compensation on at least N−1 of the physical channels when the optical signals are received at the receiver. In some embodiments phase compensation may be provided on all N of the physical channels.

In some embodiments, N is two and only a single mixing coupler is used. In some embodiments, where N=4, two optical mixing devices are used, as illustrated with regard to the coupler arrangements in FIGS. 2C and 2D above. The optical mixing devices could be either, or both, of four port 3 dB couplers and four port 180-degree hybrid couplers. In some embodiments, the one optical mixer could be a collection of tunable couplers with N inputs and N outputs that mixes the N input optical signals in a way that is the inverse of the transmitter mixing device or devices so as to recover the original modulated synchronous optical signals.

Numerous modifications and variations of the present disclosure are possible in light of the above teachings. It is therefore to be understood that within the scope of the appended claims, the disclosure may be practised otherwise than as specifically described herein.

1. A device comprising:
an optical mixer configured to:
receive N modulated synchronous optical signals, N≧2, having a same carrier wavelength;
coherently mix the modulated synchronous optical signals and generate N mixed optical signals, each mixed optical signal including a respective component of at least two of the N modulated synchronous optical signals; and
output each mixed optical signal on a respective physical channel.

2. The device of claim 1 wherein each physical channel comprises a separate optical fiber.

3. The device of claim 1 wherein N=2 and the optical mixer comprises a single four port optical coupler, and wherein optical signals output from the four port optical coupler are the N mixed optical signals.

4. The device of claim 3 wherein the four port optical coupler is a four port 3 dB coupler or a four port 180-degree hybrid coupler.

5. The device of claim 1 wherein N=4 and the optical mixer comprises first, second, third and fourth four optical mixing devices arranged such that:
the first optical mixing device receives first and second modulated synchronous optical signals and the second optical mixing device receives third and fourth modulated synchronous optical signals;
a first output from the first optical mixing device is optically coupled to a first input of the third optical mixing device and a first output from the second optical mixing device is optically coupled to a second input of the third optical mixing device;
a second output from the first optical mixing device is optically coupled to a first input of the fourth optical mixing device and a second output from the second optical mixing device is optically coupled to a second input of the fourth optical mixing device; and
outputs of the third and fourth optical mixing devices comprise the N mixed optical signals.

6. The device of claim 5 wherein the first to fourth optical mixing devices are selected from a group that consists of four port 3 dB couplers and four port 180-degree hybrid couplers.

7. The device of claim 1 wherein the optical mixer comprises an analog optical switch comprising a collection of tunable couplers.

8. The device of claim 1 further comprising N modulators, each modulator optically coupled to an optical input of the optical mixer in order to generate one of the modulated synchronous optical signals by modulating an optical signal from an optical source.

9. The device of claim 8 where the optical source is one of:
a single laser optically coupled to all of the N modulators; or
two or more lasers, locked to the same carrier wavelength, each laser optically coupled to one or more of the N modulators.

10. The device of claim 1 further comprising at least one optical phase adjust element or at least one time variable adjust element optically coupled to at least one input of the optical mixer.

11. A method comprising:
coherently mixing N modulated synchronous optical signals, N≧2, having a same carrier wavelength, to generate an equivalent number of mixed optical signals, each mixed optical signal including a respective component of at least two of the N modulated synchronous optical signals; and
transmitting each mixed optical signal on a respective physical channel.

12. The method of claim 11 wherein transmitting each mixed optical signal comprises transmitting at least one of the mixed optical signals on a physical route that is distinct from a physical route or routes on which all other mixed optical signals are transmitted.

13. The method of claim 12 wherein transmitting each mixed optical signal comprises transmitting each of the mixed optical signals on a physical route that is distinct from a physical route of each other mixed optical signal.

14. The method of claim 11 wherein coherently mixing the N modulated synchronous optical signals comprises mixing at least two of the N modulated synchronous optical signals using an optical mixer.

15. The method of claim 14 wherein N=4 and the optical mixer comprises four optical mixing devices that are selected from a group consisting of four port 3 dB couplers and four port 180-degree hybrid couplers.

16. The method of claim 11 wherein coherently mixing the N modulated synchronous optical signals comprises mixing at least two of the N modulated synchronous optical signals together using an analog optical switch comprising a collection of tunable couplers.

17. The method of claim 11 further comprising controlling polarization of one or more of the modulated optical signals to enhance a level of obfuscation.

18. The method of claim 11 further comprising modulating a plurality of synchronous optical signals with respective optical modulators to produce the N modulated synchronous optical signals.

19. The method of claim 11 further comprising controlling the power of the N modulated synchronous optical signals to be substantially equal in power before they are mixed.

20. A device comprising:
an optical mixer configured to:
receive N optical signals, N≧2 each on a respective physical channel, each optical signal including a respective component of each of at least two of N modulated synchronous optical signals from an originating transmission source; and
coherently mix the received optical signals to recover the N modulated synchronous optical signals.

21. The device of claim 20 further comprising at least one optical phase adjust element or at least one time variable adjust element optically coupled to at least one input of the optical mixer.

22. The device of claim 20 wherein each physical channel comprises a separate optical fiber.

23. The device of claim 21 wherein N=2, and the optical mixer comprises a four port optical coupler, and wherein optical signals output from the four port optical coupler are proportional to the respective N modulated synchronous optical signals.

24. The device of claim 23 wherein the four port optical coupler is a four port 3 dB coupler or a four port 180-degree hybrid coupler.

25. The device of claim 21 wherein N=4, and the optical mixer comprises first, second, third and fourth optical mixing devices arranged such that:
the first optical mixing device receives first and second received optical signals and the second optical mixing device receives third and fourth received optical signals;
a first output from the first optical mixing device is optically coupled to a first input of the third optical mixing device and a first output from the second optical mixing device is optically coupled to a second input of the third optical mixing device;
a second output from the first optical mixing device is optically coupled to a first input of the fourth optical mixing device and a second output from the second optical mixing device is optically coupled to a second input of the fourth optical mixing device; and
outputs of the third and fourth optical mixing devices are proportional to the respective N modulated optical signals.

26. The device of claim 25 wherein the first to fourth optical mixing devices are selected from a group consisting of four port 3 dB couplers and four port 180-degree hybrid couplers.

27. The device of claim 20 wherein the optical mixer comprises an analog optical switch comprising a collection of tunable couplers.

28. A method comprising:
receiving N optical signals, N≧2, from N respective physical channels, each received optical signal including a respective component of each of at least two of N modulated synchronous optical signals from an originating transmission source; and
recovering the N modulated synchronous optical signals by coherently mixing the N received optical signals.

29. The method of claim 28 further comprising providing phase compensation on at least N−1 of the physical channels.

30. The method of claim 28 wherein coherently mixing the N received optical signals comprises mixing at least two of the N optical signals using an optical mixer.

31. The method of claim 30 wherein the optical mixer comprises four optical mixing devices selected from a group consisting of four port 3 dB couplers and four port 180-degree hybrid couplers.

32. The method of claim 28 wherein coherently mixing the plurality of received optical signals together comprises mixing at least two of the N optical signals together using an analog optical switch comprising a collection of tunable couplers.

33. A system comprising:
a transmitter;
a receiver; and
at least two physical channels connecting the transmitter and receiver;
the transmitter comprising:
a first optical mixer configured to:
receive N modulated synchronous optical signals, N≧2, having a same carrier wavelength;
coherently mix the modulated synchronous optical signals and generate N mixed optical signals, each mixed optical signal including a respective component of at least two of the modulated synchronous optical signals; and
output each mixed optical signal on the at least two respective physical channels;
the receiver comprising:
a second optical mixer configured to:
receive N mixed optical signals from the at least two physical channels; and
coherently mix the received mixed optical signals to recover the N modulated synchronous optical signals.
